(19) United States
(12) Patent Application Publication
(10) Pub. No.: US 2025/0067614 A1
(43) Pub. Date: Feb. 27, 2025

(54) BALANCE INSPECTION APPARATUS, BALANCE INSPECTION METHOD, BALANCE-INSPECTED CRANKSHAFT, ARITHMETIC PROCESSING DEVICE, AND PROGRAM

(71) Applicant: NIPPON STEEL CORPORATION, Tokyo (JP)

(72) Inventors: Yoshito ISEI, Tokyo (JP); Ryusuke NAKANO, Tokyo (JP); Ryota OHASHI, Tokyo (JP)

(73) Assignee: NIPPON STEEL CORPORATION, Tokyo (JP)

(21) Appl. No.: 18/725,007

(22) PCT Filed: Sep. 5, 2022
(86) PCT No.: PCT/JP2022/033233

§ 371 Date: Jun. 27, 2024

(30) Foreign Application Priority Data
Dec. 28, 2021 (JP) 2021-214795

(51) Int. Cl. G01M 1/24; G01M 1/12

(52) U.S. Cl. CPC G01M 1/24; G01M 1/122

(57) ABSTRACT

An arithmetic processing unit of a balance inspection apparatus generates three-dimensional point cloud data based on measurement results of surface shape measuring parts, generates surface data based on the three-dimensional point cloud data that have been aligned with a surface shape model defined in a coordinate system in which a designed rotation center axis of a crankshaft is an X axis, extracts evaluation object data, which are surface data of an evaluation object portion including an arm of the crankshaft, calculates gravitational centers and areas of cross sections orthogonal to the X axis at a plurality of positions along the X axis of the evaluation object data, calculates a gravitational center and a weight of the evaluation object data based on the gravitational centers of the cross sections and predetermined weights set according to the areas of the cross sections, and calculates an imbalance amount of the crankshaft.

### TECHNICAL FIELD

The present invention relates to a balance inspection apparatus for a crankshaft used in automobile engines, and the like, a balance inspection method, a balance-inspected crankshaft, an arithmetic processing device, and a program.

### BACKGROUND ART

FIG. 1A and FIG. 1B each are a view schematically illustrating one example of a crankshaft (crankshaft for inline four-cylinder engine). FIG. 1A is a front view of a crankshaft S viewed from the direction of a rotation center axis L, and FIG. 1B is a side view of the crankshaft S viewed from the direction orthogonal to the rotation center axis L.

As illustrated in FIG. 1A and FIG. 1B, the crankshaft S includes a front SA provided on the rotation center axis L of the crankshaft S, a plurality of journals SB provided on the rotation center axis L (in the example illustrated in FIG. 1A and FIG. 1B, a first journal SB1 to a fifth journal SB5), a plurality of arms provided on the rotation center axis L (in the example illustrated in FIG. 1A and FIG. 1B, a first arm SC1 to an eighth arm SC8), a plurality of pins SD for attaching connecting rods (not illustrated) each provided at a predetermined angular position around the rotation center axis L (in the example illustrated in FIG. 1A and FIG. 1B, a first pin SD1 to a fourth pin SD4), and a flange SE provided on the rotation center axis L.

Some of the arms SC have a counterweight for balancing the rotation. The cross-sectional shape of the counterweight-attached arm SC is a symmetrical complex shape. The cross-sectional shape of the pin SD is a circular shape centered at a position away from the rotation center axis L, and the cross-sectional shapes of the front SA, the journals SB, and the flange SE, which are shaft portions of the crankshaft S corresponding to shaft parts of an engine, are a circular shape centered on the rotation center axis L of the crankshaft S.

The crankshaft S illustrated in FIG. 1A and FIG. 1B is manufactured as follows: a heated material is pressed with upper and lower dies to be subjected to die forging, and thereby a forged product including flash is formed, and then the forged product is subjected to trimming to remove the flash and is subjected to shot blasting. The crankshaft S manufactured through these manufacturing processes is machined by cutting so as to be incorporated appropriately when incorporated into an automobile engine or another part. Specifically, the shaft portions (the front SA, the journals SB, and the flange SE) and the pins SD of the crankshaft S are machined to have a cylindrical shape. These shaft portions and pins SD are each provided with a machining stock of about several millimeters during manufacture to enable machining.

Here, eccentricity may occur in the crankshaft S due to defects in a mold for casting the material, defects in a die for forging the material, effects during trimming or die cutting, or other reasons. The above-described machining is mainly performed on the journals SB and the pins SD, and thus the eccentricity in the journals SB and the pins SD is eliminated. However, the eccentricity may remain in the counterweight-attached arm SC, which is hardly machined, resulting in that the crankshaft S as a whole may still be imbalanced during rotation.

Since the crankshaft S is used while being incorporated into an engine, if the gravitational center and the weight of the arm SC deviate from designed values, imbalance occurs during engine rotation, causing problems such as vibration. Therefore, it is necessary to keep the imbalance amount (moment), which is information on the balance of the crankshaft S, within a predetermined tolerance value.

Generally, a rotating body that rotates around a certain axis can be balanced by adding an appropriate weight to two certain points. In the case of the crankshaft S, these two points are generally the journals SB at both ends (the first journal SB1 and the fifth journal SB5 illustrated in FIG. 1B), and by calculating the amount of imbalance that occurs at the journals SB at both ends, the balancing status of the crankshaft S can be checked. The amount of imbalance that occurs at the journals SB at both ends can be calculated by distributing the amount of imbalance determined by the gravitational centers and the weights of a plurality of the counterweight-attached arms SC or the like to the journals SB at both ends.

FIG. 2A and FIG. 2B are views each explaining a method of distributing an imbalance amount of a rotating body to both ends. FIG. 2A is an explanatory view of a method of distributing an imbalance amount Mᵢ to both ends (an A side and a B side), and FIG. 2B is an explanatory view of the imbalance amount Mᵢ.

As illustrated in FIG. 2A and FIG. 2B, in the case where a point O on the X axis of the X axis, the Y axis, and the Z axis orthogonal to one another is a reference point and the imbalance amount Mᵢ expressed by the moment determined by a weight mᵢ and a gravitational center (Zᵢ, yᵢ) exists at a position of xᵢ (i=1 to n) along the X-axis direction from the point O, the imbalance amount Mᵢ is expressed by Equation (1) and Equation (2) below. Incidentally, in Equation (1), M_{iz} refers to a Z-axis component of Mᵢ and M_{iy} refers to a Y-axis component of Mi, respectively.

Then, the imbalance amount Mᵢ is divided into an imbalance amount M_{A} on the A side, calculated by Equations (3) and (4) below, and an imbalance amount M_{B} on the B side, calculated by Equations (5) and (6) below. In other words, the state where the imbalance amount Mᵢ occurs is equivalent to the state where the imbalance amounts M_{A} and M_{B} occur at both ends. Incidentally, M_{AZ} in Equation (3) refers to a Z-axis component of M_{A}, M_{AY} in Equation (4) refers to a Y-axis component of M_{A}, M_{BZ} in Equation (5) refers to a Z-axis component of M_{B}, and M_{BY} in Equation (6) refers to a Y-axis component of M_{B}, respectively. LL in each of Equation (3) to Equation (6) refers to the distance between the both ends (the A side and the B side).

$$[ Mathematical equation 1 ]$$

$$\begin{matrix}[ Mathematical equation 1 ] & \\ {M}_{iz} = {m}_{i} \cdot {z}_{i} = {m}_{i} * {r}_{i} * cos {θ}_{i} & ( 1 )\end{matrix}$$

$${M}_{iy} = {m}_{i} * {y}_{i} = {m}_{i} * {r}_{i} \cdot sin {θ}_{i} \qquad ( 2 )$$

$${M}_{A z} = {\sum }_{i = 1}^{n} \frac{{M}_{iz} ( LL - {x}_{i} )}{L L} = {\sum }_{i = 1}^{n} {M}_{i z} - {\sum }_{i = 1}^{n} \frac{{M}_{i z} {x}_{i}}{L L} \qquad ( 3 )$$

$${M}_{Ay} = {\sum }_{i = 1}^{n} \frac{{M}_{iy} ( LL - {x}_{i} )}{L L} = {\sum }_{i = 1}^{n} {M}_{iy} - {\sum }_{i = 1}^{n} \frac{{M}_{iy} {x}_{i}}{L L} \qquad ( 4 )$$

$${M}_{B z} = {\sum }_{i = 1}^{n} \frac{{M}_{i z} {x}_{i}}{L L} \qquad ( 5 )$$

$${M}_{By} = {\sum }_{i = 1}^{n} \frac{{M}_{iy} {x}_{i}}{L L} \qquad ( 6 )$$

When the rotating body is the crankshaft S, the imbalance amounts M_{A} and M_{B} are calculated by setting the A side as the first journal SB1 and setting the B side as the fifth journal SB5.

Then, at the time of machining, there are taken measures in which balance measurement is performed by actually rotating the crankshaft S around the designed rotation center axis L using, for example, a well-known balance measuring apparatus (see, for example, Patent Literature 1) to find the balance center axis where the rotation of the crankshaft S is balanced, and a center hole is formed in both end surfaces (the front SA and the flange SE) of the crankshaft S on this balance center axis to be machined. Specifically, by performing machining with a straight line passing through the center holes in the both end surfaces as the center axis, a well-balanced crankshaft S can be manufactured.

Further, in the case where at the final stage of machining, the balance around the rotation center axis L is measured again by the balance measuring apparatus and imbalance occurs, the balance is finely adjusted by drilling a hole in the counterweight of the arm SC.

As long as the surface of the crankshaft S is finished to an ideal shape as designed, the imbalance amounts M_{A} and M_{B} can be easily brought within the tolerance value. Even if the balance is shifted by subsequent machining, the balance can be easily adjusted by drilling a hole in the counterweight of the arm SC finally.

Here, as a technique to measure the surface shape of a crankshaft and inspect the balance of the crankshaft, techniques described in Patent Literatures 2 and 3 have been proposed.

The technique described in Patent Literature 2 is a rotary machining method that takes in a measured three-dimensional shape of a crankshaft, calculates the shape after rotary machining by removing (subtracting) excess portions from a finished shape after rotary machining created by simulation, calculates the balance while shifting this calculated position, and finds the balance center axis (the rotation center in Patent Literature 2).

In the technique described in Patent Literature 2, in order to subtract the finished shape after rotary machining created by simulation from the measured three-dimensional shape when calculating the shape after rotary machining, it is necessary to perform the processing while using each shape as a three-dimensional body with volume. The measured shape is obtained as point cloud data of the surface, and thus the point cloud data are converted to surface data expressed by a triangular mesh or the like and then solidification processing is performed, and thereby the measured shape can be handled as a three-dimensional body finally. Therefore, the technique described in Patent Literature 2 has the problem that time is required for the solidification processing or that the processing cannot be performed because the surface data are not closed due to a missing part in measurement results.

The technique described in Patent Literature 3 is a shape inspection device that creates a temporary determination three-dimensional model by supplementing an unmeasurable portion of a measured three-dimensional shape of a crankshaft with a temporary complementary three-dimensional model, selects from among a plurality of complementary three-dimensional models, the complementary three-dimensional model that emphasizes the tendency of the temporary determination three-dimensional model the most, creates a determination three-dimensional model that has supplemented the unmeasurable portion, and determines whether or not this determination three-dimensional model meets predetermined criteria.

According to the technique described in Patent Literature 3, it is possible to deal with the problem in the technique described in Patent Literature 2 that the processing cannot be performed because the surface data are not closed due to a missing part in measurement results. However, similarly to the technique described in Patent Literature 2, even the technique described in Patent Literature 3 fails to solve the problem that time is required for the solidification processing.

Incidentally, in Patent Literature 4, there has been proposed a shape inspection apparatus capable of accurately calculating the shape of a crankshaft by applying isolated point removal processing, or the like to three-dimensional point cloud data of the surface of the crankshaft.

### CITATION LIST

### Patent Literature

Patent Literature 1: Japanese Laid-open Patent Publication No. 2004-45386

Patent Literature 2: Japanese Laid-open Patent Publication No. 2007-264749

Patent Literature 3: Japanese Laid-open Patent Publication No. 2007-212357

Patent Literature 4: Japanese Laid-open Patent Publication No. 2021-103089

### SUMMARY OF INVENTION

### Technical Problem

The present invention has been made in order to solve the above-described problems of the prior arts, and has an object to enable high-speed calculation of information on the balance of a crankshaft even if there is a missing part in a measurement result of a surface shape of the crankshaft.

### Solution to Problem

To solve the aforementioned object, the present invention is a balance inspection apparatus that calculates information on balance of a crankshaft, and there is provided a balance inspection apparatus including: a plurality of surface shape measuring parts that are each arranged around a rotation center axis of the crankshaft and optically measure a surface shape of the crankshaft; a positioning device part that moves the surface shape measuring part relative to the crankshaft in the direction of the rotation center axis of the crankshaft; a storage unit that stores a surface shape model, the surface shape model in which a designed surface shape of the crankshaft is defined in a coordinate system in which a designed rotation center axis of the crankshaft is an X axis; and an arithmetic processing unit that calculates information on balance of the crankshaft based on measurement results of a plurality of the surface shape measuring parts, wherein a plurality of the surface shape measuring parts are arranged to measure a surface shape of the crankshaft over substantially the entire circumference and moved relative to the crankshaft by the positioning device part, to thereby measure a surface shape of the crankshaft over substantially the entire length, and the arithmetic processing unit combines measurement results of a plurality of the surface shape measuring parts, to thereby generate three-dimensional point cloud data consisting of data points corresponding to points of a surface of the crankshaft, aligns the three-dimensional point cloud data with the surface shape model read from the storage unit in a coordinate system of the surface shape model, based on the three-dimensional point cloud data that have been aligned, generates surface data represented by a collection of planes passing through three data points that constitute the three-dimensional point cloud data, extracts, from the surface data, evaluation object data, which are surface data of an evaluation object portion including at least an arm of the crankshaft, and calculates gravitational centers and areas of cross sections orthogonal to the X axis at a plurality of positions along the X axis of the evaluation object data, calculates a gravitational center and a weight of the evaluation object data based on the gravitational centers of the cross sections and predetermined weights set according to the areas of the cross sections, and calculates information on balance of the crankshaft based on the gravitational center and the weight of the evaluation object data.

Further, to solve the aforementioned object, the present invention is a balance inspection method that calculates information on balance of a crankshaft, and is also provided as a balance inspection method including: using a balance inspection apparatus including: a plurality of surface shape measuring parts that are each arranged around a rotation center axis of the crankshaft and optically measure a surface shape of the crankshaft; a positioning device part that moves the surface shape measuring part relative to the crankshaft in the direction of the rotation center axis of the crankshaft; a storage unit that stores a surface shape model, the surface shape model in which a designed surface shape of the crankshaft is defined in a coordinate system in which a designed rotation center axis of the crankshaft is an X axis; and an arithmetic processing unit that calculates information on balance of the crankshaft based on measurement results of a plurality of the surface shape measuring parts; a surface shape measurement step that arranges a plurality of the surface shape measuring parts to measure a surface shape of the crankshaft over substantially the entire circumference and moves a plurality of the surface shape measuring parts relative to the crankshaft by the positioning device part, to thereby measure a surface shape of the crankshaft over substantially the entire length; a three-dimensional point cloud data generation step that uses the arithmetic processing unit and combines measurement results of a plurality of the surface shape measuring parts, to thereby generate three-dimensional point cloud data consisting of data points corresponding to points of a surface of the crankshaft; an alignment step that aligns the three-dimensional point cloud data with the surface shape model read from the storage unit in a coordinate system of the surface shape model; a surface data generation step that, based on the three-dimensional point cloud data that have been aligned, generates surface data represented by a collection of planes passing through three data points that constitute the three-dimensional point cloud data; a first calculation step that extracts, from the surface data, evaluation object data, which are surface data of an evaluation object portion including at least an arm of the crankshaft, and calculates gravitational centers and areas of cross sections orthogonal to the X axis at a plurality of positions along the X axis of the evaluation object data; a second calculation step that calculates a gravitational center and a weight of the evaluation object data based on the gravitational centers of the cross sections and predetermined weights set according to the areas of the cross sections; and a third calculation step that calculates information on balance of the crankshaft based on the gravitational center and the weight of the evaluation object data.

Further, to solve the aforementioned object, the present invention is an arithmetic processing device that calculates information on balance of a crankshaft, and is also provided as an arithmetic processing device including: a storage means that stores a surface shape model, the surface shape model in which a designed surface shape of the crankshaft is defined in a coordinate system in which a designed rotation center axis of the crankshaft is an X axis; an alignment means that aligns three-dimensional point cloud data, the three-dimensional point cloud data generated based on results obtained by optically measuring a surface shape of the crankshaft and consisting of data points corresponding to points of a surface of the crankshaft, with the surface shape model read from the storage means in a coordinate system of the surface shape model; a surface data generation means that, based on the three-dimensional point cloud data that have been aligned in the alignment means, generates surface data represented by a collection of planes passing through three data points that constitute the three-dimensional point cloud data; a first calculation means that extracts, from the surface data generated in the surface data generation means, evaluation object data, which are surface data of an evaluation object portion including at least an arm of the crankshaft, and calculates gravitational centers and areas of cross sections orthogonal to the X axis at a plurality of positions along the X axis of the evaluation object data; a second calculation means that calculates a gravitational center and a weight of the evaluation object data based on the gravitational centers of the cross sections calculated in the first calculation means and predetermined weights set according to the areas of the cross sections calculated in the first calculation means, and a third calculation means that calculates information on balance of the crankshaft based on the gravitational center and the weight of the evaluation object data calculated in the second calculation means.

Further, to solve the aforementioned object, the present invention is a balance inspection method that calculates information on balance of a crankshaft, and is also provided as a balance inspection method including: using a storage means that stores a surface shape model, the surface shape model in which a designed surface shape of the crankshaft is defined in a coordinate system in which a designed rotation center axis of the crankshaft is an X axis; an alignment step that aligns three-dimensional point cloud data, the three-dimensional point cloud data generated based on results obtained by optically measuring a surface shape of the crankshaft and consisting of data points corresponding to points of a surface of the crankshaft, with the surface shape model read from the storage means in a coordinate system of the surface shape model; a surface data generation step that, based on the three-dimensional point cloud data that have been aligned at the alignment step, generates surface data represented by a collection of planes passing through three data points that constitute the three-dimensional point cloud data; a first calculation step that extracts, from the surface data generated at the surface data generation step, evaluation object data, which are surface data of an evaluation object portion including at least an arm of the crankshaft, and calculates gravitational centers and areas of cross sections orthogonal to the X axis at a plurality of positions along the X axis of the evaluation object data; a second calculation step that calculates a gravitational center and a weight of the evaluation object data based on the gravitational centers of the cross sections calculated at the first calculation step and predetermined weights set according to the areas of the cross sections calculated at the first calculation step, and a third calculation step that calculates information on balance of the crankshaft based on the gravitational center and the weight of the evaluation object data calculated at the second calculation step.

Further, to solve the aforementioned object, the present invention is a program intended for calculating information on balance of a crankshaft, and is also provided as a program causing a computer to execute: a storage means that stores a surface shape model, the surface shape model in which a designed surface shape of the crankshaft is defined in a coordinate system in which a designed rotation center axis of the crankshaft is an X axis; an alignment means that aligns three-dimensional point cloud data, the three-dimensional point cloud data generated based on results obtained by optically measuring a surface shape of the crankshaft and consisting of data points corresponding to points of a surface of the crankshaft, with the surface shape model read from the storage means in a coordinate system of the surface shape model; a surface data generation means that, based on the three-dimensional point cloud data that have been aligned in the alignment means, generates surface data represented by a collection of planes passing through three data points that constitute the three-dimensional point cloud data; a first calculation means that extracts, from the surface data generated in the surface data generation means, evaluation object data, which are surface data of an evaluation object portion including at least an arm of the crankshaft, and calculates gravitational centers and areas of cross sections orthogonal to the X axis at a plurality of positions along the X axis of the evaluation object data; a second calculation means that calculates a gravitational center and a weight of the evaluation object data based on the gravitational centers of the cross sections calculated in the first calculation means and predetermined weights set according to the areas of the cross sections calculated in the first calculation means, and a third calculation means that calculates information on balance of the crankshaft based on the gravitational center and the weight of the evaluation object data calculated in the second calculation means.

### Advantageous Effects of Invention

According to the present invention, even if there is a missing part in a measurement result of a surface shape of a crankshaft, information on the balance of the crankshaft can be calculated at high speed.

### BRIEF DESCRIPTION OF DRAWINGS

FIG. 1A is a view schematically illustrating one example of a crankshaft.

FIG. 1B is a view schematically illustrating one example of the crankshaft.

FIG. 2A is a view explaining a method of distributing an imbalance amount of a rotating body to both ends.

FIG. 2B is a view explaining the method of distributing the imbalance amount of the rotating body to the both ends.

FIG. 3A is a view illustrating a schematic configuration of a balance inspection apparatus according to an embodiment.

FIG. 3B is a view illustrating a schematic configuration of the balance inspection apparatus according to the embodiment.

FIG. 3C is a diagram illustrating a functional configuration of an arithmetic processing unit of an arithmetic processing device according to the embodiment.

FIG. 4 is a view illustrating one example of three-dimensional point cloud data that have been subjected to isolated point removal processing.

FIG. 5 is a view illustrating one example of surface data.

FIG. 6A is a view schematically explaining an estimating method of evaluation object data after machining.

FIG. 6B is a view schematically explaining the estimating method of the evaluation object data after machining.

FIG. 7 is a view illustrating a table where examples of results obtained by calculating a gravitational center and a weight of evaluation object data by balance inspection apparatuses according to an embodiment, a reference example, and a comparative example are summarized.

FIG. 8A is a view illustrating one example of a result obtained by calculating the imbalance amount of the crankshaft by the balance inspection apparatus according to the comparative example.

FIG. 8B is a view illustrating one example of a result obtained by calculating the imbalance amount of the crankshaft by the balance inspection apparatus according to the example.

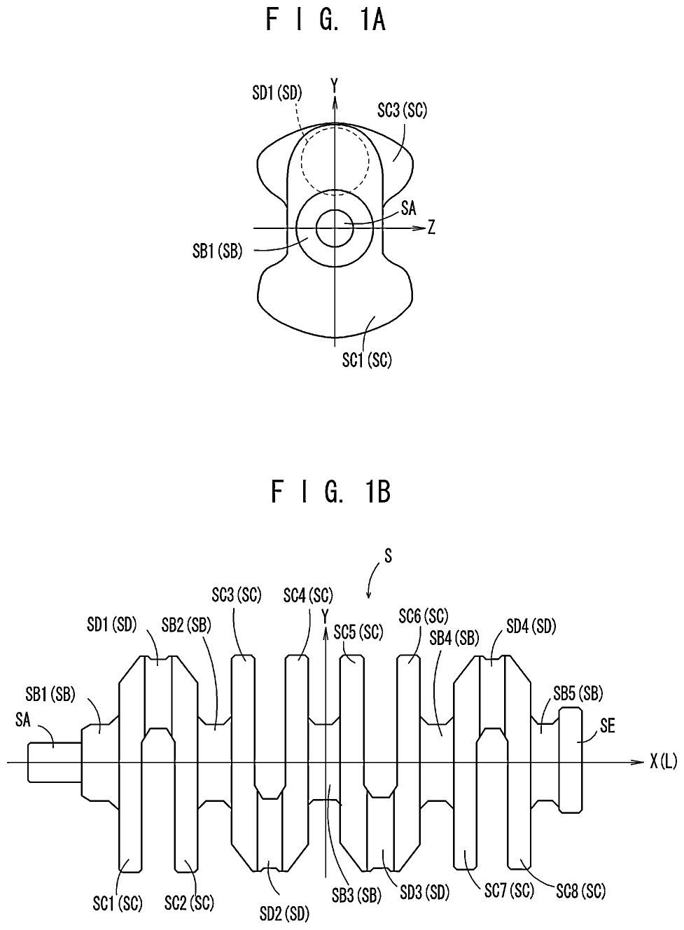

### DESCRIPTION OF EMBODIMENTS

Referring to the accompanying drawings as appropriate, one embodiment of the present invention will be explained below, using, as an example, the case of measuring the surface shape of a crankshaft before machining and calculating (estimating) an imbalance amount of the crankshaft after machining.

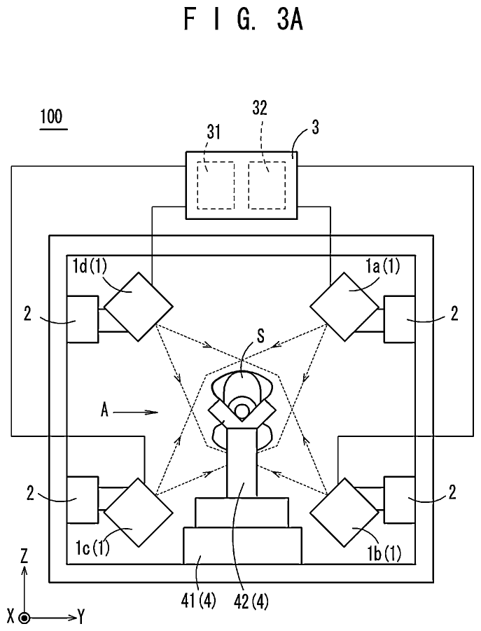

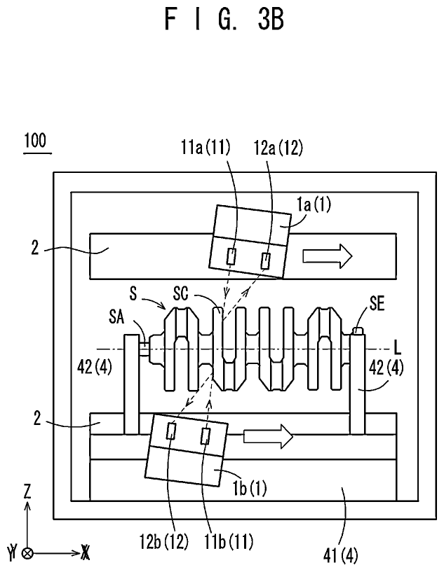

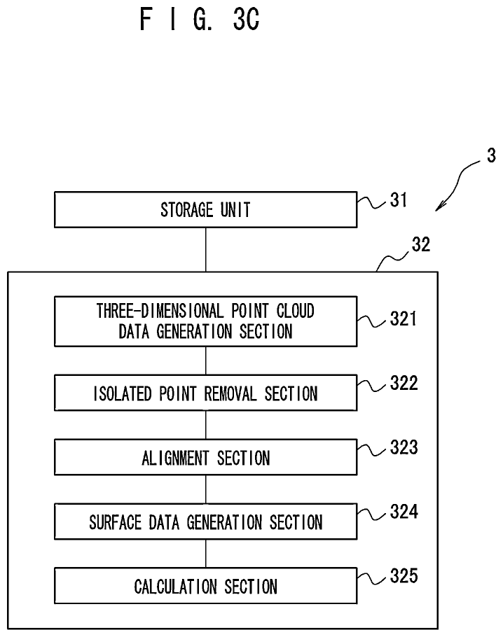

FIG. 3A and FIG. 3B are views each schematically illustrating a schematic configuration of a balance inspection apparatus according to the embodiment. FIG. 3A is a front perspective view of a crankshaft S viewed from the direction of a rotation center axis L (X-axis direction). FIG. 3B is a side view viewed from the direction indicated by an arrow A in FIG. 3A. Incidentally, in FIG. 3A and FIG. 3B, the direction of the designed rotation center axis L of the crankshaft S when the crankshaft S is not bent or twisted is set to an X-axis direction, the horizontal direction orthogonal to the rotation center axis L of the crankshaft S is set to a Y-axis direction, and the vertical direction orthogonal to the rotation center axis L of the crankshaft S is set to a Z-axis direction. Further, in FIG. 3B, the illustration of an arithmetic processing device 3 is omitted.

As illustrated in FIG. 3A to FIG. 3C, a balance inspection apparatus 100 according to this embodiment is an apparatus that calculates an imbalance amount of the crankshaft S, and includes surface shape measuring parts 1, positioning device parts 2, the arithmetic processing device 3 including a storage unit 31 and an arithmetic processing unit 32, and a support part 4. In this embodiment, the storage unit 31 and the arithmetic processing unit 32 are integrated to configure the arithmetic processing device 3, but the present invention is not limited to this, and the storage unit 31 and the arithmetic processing unit 32 may be provided separately to configure the arithmetic processing device 3.

The surface shape measuring part 1 is to optically measure the surface shape of the crankshaft S by projecting and receiving light on and from the crankshaft S. Specifically, the surface shape measuring part 1 includes a light-projecting part 11 that projects linear laser light extending in the direction orthogonal to the rotation center axis L of the crankshaft S toward the crankshaft S, and a light-receiving part 12 that receives light reflected on the surface of the crankshaft S and captures an image, and is configured to measure the surface shape of the crankshaft S by an optical cutting method that analyzes the deformation of the linear laser light. By using a plurality of the surface shape measuring parts 1 using an optical cutting method, the surface shape of the crankshaft S can be measured at high speed, which has the advantage of facilitating a total inspection of the crankshaft S.

However, as the surface shape measuring part 1, the present invention is not limited to this, and can also employ a configuration to measure the surface shape of the crankshaft S using a spatial encoding method by projecting a stripe pattern or a grid pattern.

In the surface shape measuring part 1 in this embodiment, when the distance to the crankshaft S is 400 mm, the measurement field of view in the circumferential direction of the crankshaft S is 180 mm. Further, the measurement resolution of the crankshaft S in the circumferential direction is 0.3 mm, and the measurement resolution of the crankshaft S in the radial direction when the measurement cycle is 500 Hz is about 0.02 mm. As such a surface shape measuring part 1, for example, an ultra-high-speed in-line profilometer “LJ-V7300” manufactured by KEYENCE CORPORATION can be used. When the surface shape measuring part 1 is moved at 200 mm/sec in the X-axis direction by the later-described positioning device part 2, it is possible to measure the three-dimensional shape of the surface of the crankshaft S in which the measurement resolution in the X-axis direction is 0.4 mm, the measurement resolution of the crankshaft S in the circumferential direction is 0.3 mm, and the measurement resolution of the crankshaft S in the radial direction is 0.02 mm.

The balance inspection apparatus 100 includes a plurality of the surface shape measuring parts 1 each arranged around the rotation center axis L of the crankshaft S. The balance inspection apparatus 100 according to this embodiment includes four surface shape measuring parts 1a to 1d each arranged around the rotation center axis L of the crankshaft S at a pitch of 90°. As illustrated in FIG. 3B, the surface shape measuring part 1a includes a light-projecting part 11a and a light-receiving part 12a, and the surface shape measuring part 1b includes a light-projecting part 11b and a light-receiving part 12b. Although not illustrated, the same is true for the surface shape measuring parts 1c and 1d. With the four surface shape measuring parts 1a to 1d provided in this manner, without rotating the crankshaft S around the rotation center axis L, the surface shape of the crankshaft S over substantially the entire circumference can be measured, and by the positioning device part 2 moving the surface shape measuring part 1 in the X-axis direction, the surface shape of the crankshaft S over substantially the entire length can be measured. That is, the three-dimensional shape of substantially the entire surface of the crankshaft S can be measured.

Incidentally, the balance inspection apparatus 100 in this embodiment includes the four surface shape measuring parts 1, but the present invention is not limited to this, and a configuration including any plurality of surface shape measuring parts 1 can be employed as long as the surface shape of the crankshaft S over substantially the entire circumference is measured.

Then, in this embodiment, among the four surface shape measuring parts 1, the surface shape measuring parts 1 adjacent to each other around the rotation center axis L of the crankshaft S have their light projection directions inclined in opposite directions to each other with respect to the direction orthogonal to the rotation center axis L of the crankshaft S.

As in the surface shape measuring part 1 according to this embodiment, the light projection direction is inclined with respect to the direction orthogonal to the rotation center axis L of the crankshaft S, thereby making it possible to at least partially measure the shape of the side surface (the side surface in the direction orthogonal to the rotation center axis L of the crankshaft S) of the counterweight SC. Further, the light projection directions of the adjacent surface shape measuring parts 1 are inclined in opposite directions to each other with respect to the direction orthogonal to the rotation center axis L of the crankshaft S, thus making it possible to at least partially measure the shapes of both the side surfaces (the side surface on the front SA side and the side surface of the flange SE side) of the counterweight SC. When an inclination angle β of the surface shape measuring part 1 in the light projection direction is 5°, the measurement pitch of the side surface of the counterweight SC in the Y-axis direction is 4.5 mm (=0.4 mm/tan·5°).

Incidentally, the configuration of the surface shape measuring part 1 is the same as that of the “three-dimensional shape measuring device 1” described in Patent Literature 4, and thus its further detailed explanation is omitted here.

The positioning device part 2 is to move the surface shape measuring part 1 in the direction of the rotation center axis L of the crankshaft S (X-axis direction) relative to the crankshaft S. As the positioning device part 2, for example, a uniaxial stage can be used. As the uniaxial stage used for the positioning device part 2, the one capable of performing positioning or grasping a position with a resolution of 0.1 mm or less is preferred. In this embodiment, the positioning device part 2 is provided for each of the surface shape measuring parts 1 in order to move the four surface shape measuring parts 1 independently. Incidentally, although the positioning device part 2 in this embodiment is to move the surface shape measuring part 1, the present invention is not necessarily limited to this, and a device part to move the crankshaft S in the X-axis direction can also be used. The three-dimensional shape of substantially the entire surface of the crankshaft S can be measured by projecting and receiving light on and from the crankshaft S while the surface shape measuring part 1 moving relatively in the X-axis direction.

Incidentally, if measurement positions of the four surface shape measuring parts 1 in the X-axis direction are close to each other, the lights projected from the respective surface shape measuring parts 1 may interfere with each other, causing erroneous measurements. Therefore, for example, the four positioning device parts 2 move the surface shape measuring parts 1 respectively so that the surface shape measuring parts 1 are spaced about 200 mm apart in the X-axis direction.

The arithmetic processing device 3 includes the storage unit 31 and the arithmetic processing unit 32.

A surface shape model is stored in the storage unit 31 in advance, in which the designed surface shape of the crankshaft S (in this embodiment, the surface shape before machining) is defined in a coordinate system in which the designed rotation center axis of the crankshaft S is the X axis. Specifically, in the storage unit 31, three-dimensional CAD data based on design specifications are converted into a surface shape model formed of a triangular mesh or the like, and the surface shape model is defined in a coordinate system in which the rotation center axis is the X axis and is stored. The surface shape model only needs to be created and stored for each type of the crankshaft S, and thus, when the same type of the crankshaft S is inspected continuously, the surface shape model does not need to be created for each inspection.

Further, in addition to the above-described surface shape model, information on machining of the crankshaft S is stored in the storage unit 31 in advance. Examples of the information on machining include a movement trajectory of a cutting tool that performs machining, which is defined in the same coordinate system as the surface shape model, and a designed surface shape model of the crankshaft S after machining.

FIG. 3C illustrates a functional configuration of the arithmetic processing unit 32 of the arithmetic processing device 3. The arithmetic processing unit 32 includes a three-dimensional point cloud data generation section 321, an isolated point removal section 322, an alignment section 323, a surface data generation section 324, and a calculation section 325.

Although details of each section will be described later, measurement results of the four surface shape measuring parts 1 are input to the arithmetic processing unit 32. The arithmetic processing unit 32 calculates the imbalance amount of the crankshaft S (in this embodiment, the imbalance amount of the crankshaft S after machining) by executing a predetermined arithmetic operation using these measurement results, and the surface shape model and the information on machining stored in the storage unit 31.

The arithmetic processing device 3 is configured by a computer in which programs and applications to execute various arithmetic operations are installed to exhibit the functions as the storage unit 31 and the arithmetic processing unit 32. Specifically, for example, by mounting a well-known point cloud processing library such as open-source “PCL (Point Cloud Library)” or “HALCON” manufactured by MVTec Software GmbH on a computer, the arithmetic processing device 3 can be configured. The above-described point cloud processing library can handle surface data (data formed of a cylinder, a plane, a triangular mesh, and the like) in addition to the point cloud data, and can execute various arithmetic operations relating to point cloud data and surface data, such as pieces of preprocessing such as smoothing and thinning processing, extraction of point cloud data based on coordinates or distances, coordinate conversion, matching processing, fitting processing, dimension measurement of point cloud data, and generation of three-dimensional surfaces. The later-described isolated point removal processing can also be executed by the above-described point cloud processing library.

The support part 4 includes a base 41 and a pair of support posts 42 extending from both ends of the base 41 in the z-axis direction respectively. One of the support posts 42 supports the front SA of the crankshaft S, and the other of the support posts 42 supports the flange SE of the crankshaft S. The upper ends of the support posts 42 are V-shaped, which allows the crankshaft S to be supported in a stable posture.

Hereinafter, the operation of the balance inspection apparatus 100 will be explained, focusing mainly on the arithmetic operation contents of the arithmetic processing device 3 in the balance inspection apparatus 100 having the above-described configuration.

First, the respective surface shape measuring parts 1 (1a to 1d) measure the surface shape of the crankshaft S, and thereby, as the measurement result, three-dimensional point cloud data consisting of data points corresponding to points of the surface of the crankshaft S are acquired.

Specifically, the crankshaft S is placed on the support part 4, and the positioning device parts 2 move the four surface shape measuring parts 1 to the front SA side in the X-axis direction. Then, the surface shape of the crankshaft S over substantially the entire circumference and substantially the entire length is measured by projecting and receiving lights on and from the crankshaft S while the positioning device parts 2 moving the four three-dimensional shape measuring devices 1 to the flange SE side in the X-axis direction. At this time, in order to prevent the lights projected from the respective surface shape measuring parts 1 from interfering with each other and causing erroneous measurements, for example, the positioning device parts 2 move the respective surface shape measuring parts 1 so that the surface shape measuring parts 1 are spaced about 200 mm apart in the X-axis direction. For example, when moving the surface shape measuring parts 1 at 200 mm/s, the surface shape measuring parts 1 are each moved with a delay of 1 sec. The maximum length of the crankshaft S is about 700 mm in the case where the crankshaft S is for three- to six-cylinder engines, and thus, it is possible to acquire the three-dimensional point cloud data of the crankshaft S over substantially the entire circumference and substantially the entire length within 8 seconds, even if the moving distance is 800 mm.

The three-dimensional point cloud data of the crankshaft S over substantially the entire circumference and substantially the entire length acquired as described above are input to the arithmetic processing device 3 and stored in the storage unit 31 via Ethernet (registered trademark) or other means.

The three-dimensional point cloud data generation section 321 of the arithmetic processing unit 32 in the arithmetic processing device 3 generates three-dimensional point cloud data of substantially the entire surface of the crankshaft S by combining the measurement results (three-dimensional point cloud data) obtained by the four surface shape measuring parts 1.

As a preferred embodiment, the isolated point removal section 322 of the arithmetic processing unit 32 in the arithmetic processing device 3 performs, on the generated three-dimensional point cloud data, isolated point removal processing that removes data points whose distance to the nearest neighbor data point is equal to or more than a first threshold value Th1, in order to reduce noise caused by stray light.

Specifically, the isolated point removal section 322 concatenates, of the three-dimensional point cloud data, point cloud data in which the distance from a certain data point to the nearest neighbor data point is less than the first threshold value Th1 as one cluster, and performs labeling processing on each cluster. Then, the isolated point removal section 322 arithmetically operates the number of data points and the dimension (the distance between outermost data points located outermost of the cluster) of each of the labeled clusters, removes small clusters (for example, clusters each having 10 or less data points and a dimension of 10 mm or less), and combines only the remaining large clusters. Through such processing, only the data points (data points forming small clusters) located at a distance equal to or more than the first threshold value Th1 other than the original three-dimensional point cloud data (large clusters) corresponding to the surface of the crankshaft S are removed.

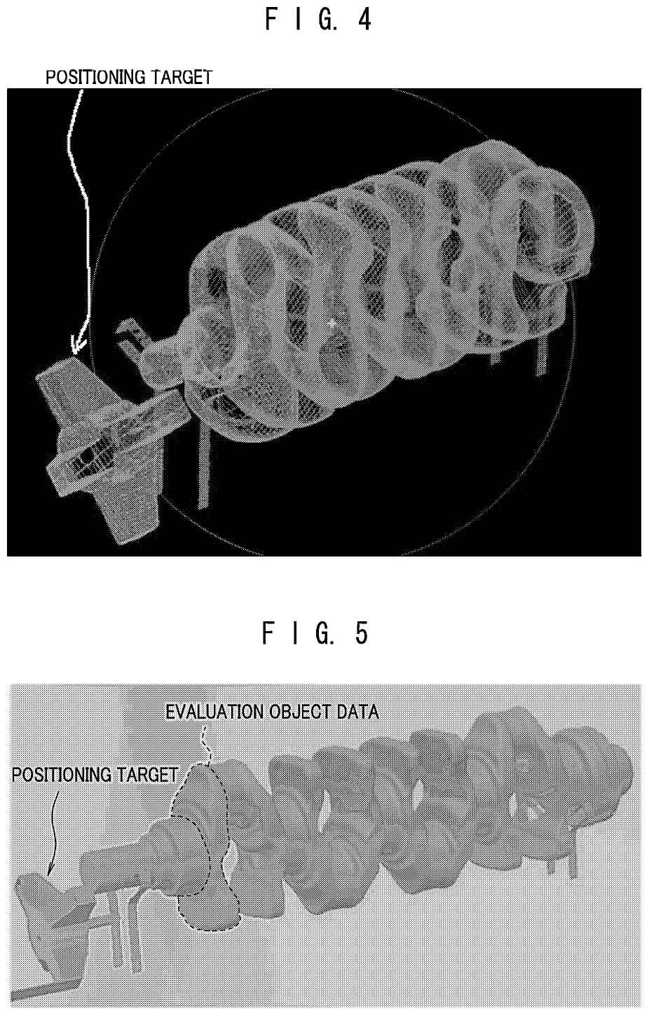

FIG. 4 is a view illustrating one example of the three-dimensional point cloud data that have been subjected to the isolated point removal processing. Specifically, FIG. 4 illustrates one example of three-dimensional point cloud data obtained after applying isolated point removal processing with the first threshold value Th1=1.0 mm to generated three-dimensional point cloud data of the crankshaft S whose surface immediately after shot blasting has a metallic luster. Incidentally, FIG. 4 also displays three-dimensional point cloud data of a positioning target used as a reference when combining the measurement results obtained by the four surface shape measuring parts 1 or for another purpose, but their detailed explanation is omitted here.

As illustrated in FIG. 4, the three-dimensional point cloud data that have been subjected to the isolated point removal processing with the small first threshold value Th1 have no noises at all near the arm SC and the noises are completely removed, although part of the point cloud data of the side surface of the arm SC is missing. In this embodiment, the imbalance amount of the crankshaft S is calculated using the three-dimensional point cloud data that have been subjected to the isolated point removal processing with the small first threshold value Th1.

Incidentally, more specific contents of the isolated point removal processing are the same as those of the isolated point removal processing described in Patent Literature 4, and thus their further detailed explanation is omitted here.

The alignment section 323 of the arithmetic processing unit 32 in the arithmetic processing device 3 aligns the three-dimensional point cloud data (three-dimensional point cloud data that have been subjected to the isolated point removal processing) with the surface shape model read from the storage unit 31 in the coordinate system of the surface shape model stored in the storage unit 31 (coordinate system in which the designed rotation center axis L of the crankshaft S is the X axis).

Specifically, the alignment section 323 first translates and rotates the three-dimensional point cloud data to make the distance between the three-dimensional point cloud data and the surface shape model minimum and superposes the translated and rotated three-dimensional point cloud data on the surface shape model. That is, the alignment section 323 translates and rotates the three-dimensional point cloud data to make the sum of the distances between the respective data points constituting the three-dimensional point cloud data and the surface shape model, or the sum of the sum of the squared distances minimum, and superposes the translated and rotated three-dimensional point cloud data on the surface shape model.

Then, the alignment section 323 extracts from the three-dimensional point cloud data superposed on the surface shape model, machining reference portion point cloud data, which are point cloud data of a predetermined machining reference portion, and translates and rotates the three-dimensional point cloud data to make the coordinates of the machining reference determined by the extracted machining reference portion point cloud data match with coordinates predetermined in the coordinate system in which the designed rotation center axis of the crankshaft S is the X axis.

As the machining reference portion, for example, of the crankshaft S, two shaft portions (specifically, the first journal SB1 and the flange SE), one pin (specifically, the first pin SD1), and two adjacent arms SC (specifically, the fourth arm SC4 and the fifth arm SC5) are set. The position of the machining reference portion can be recognized from the surface shape model superposed on the three-dimensional point cloud data. Further, as the machining reference, for example, centers of the respective two shaft portions (the first journal SB1 and the flange SE), a center of the single pin (the first pin SD1), and facing side surfaces of the two arms SC (the fourth arm SC4 and the fifth arm SC5) are set.

In this way, the alignment section 323 aligns the three-dimensional point cloud data with the surface shape model.

Incidentally, more specific procedures for the alignment, such as extraction of the machining reference portion point cloud data, calculation of the coordinates of the machining reference, and translation and rotation of the three-dimensional point cloud data, are the same as those described in Patent Literature 4, and thus their further detailed explanations are omitted here.

The surface data generation section 324 of the arithmetic processing unit 32 in the arithmetic processing device 3 generates surface data represented by a collection of planes passing through three data points that constitute the three-dimensional point cloud data (triangular meshes), based on the three-dimensional point cloud data that have been aligned.

FIG. 5 is a view illustrating one example of the surface data. FIG. 5 also displays surface data of the positioning target, as in FIG. 4, but their detailed explanation is omitted here. As illustrated in FIG. 5, in this example, part of the surface data of the side surface of the arm SC is missing.

The calculation section 325 of the arithmetic processing unit 32 in the arithmetic processing device 3 extracts, from the surface data illustrated in FIG. 5, evaluation object data, which are surface data of an evaluation object portion including at least the arm SC of the crankshaft S. At this time, as described previously, the surface data are represented by a collection of triangular meshes generated from the three-dimensional point cloud data, and thus, even if part of the original three-dimensional point cloud data is missing, the surface data corresponding to the outer edge positions exist in the process of the surface data being represented by a collection of triangular meshes. Therefore, it is easy to recognize the outer edge of the arm SC, and the position of the arm SC can be accurately extracted.

The position of the arm SC can be recognized from the surface shape model with which the surface data are aligned. In this embodiment, a plurality of (eight) arms SC (including part of the journal SB and the pin SD adjacent to each arm SC) are set as the evaluation object portion, and a plurality of (eight) pieces of evaluation object data, which are surface data of the respective evaluation object portions, are extracted. In FIG. 5 described previously, one piece of extracted evaluation object data are surrounded by a broken line.

In this embodiment, the calculation section 325 estimates evaluation object data after machining based on the extracted evaluation object data and the information on machining (movement trajectory of a cutting tool that performs machining) read from the storage unit 31. Then, the calculation section 325 calculates gravitational centers and areas of cross sections (YZ cross sections) orthogonal to the X axis at a plurality of positions along the X axis of the estimated evaluation object data (for example, positions each at a pitch of 1 mm along the X axis). At this time, as described above, the surface data are represented by a collection of triangular meshes generated from the three-dimensional point cloud data, and thus, even if part of the original three-dimensional point cloud data is missing, the surface data corresponding to the outer edge positions exist in the process of the surface data being represented by a collection of triangular meshes, and even if cross sections are set at an arbitrary pitch, the gravitational centers and the areas of the cross sections can always be calculated.

As above, the calculation section 325 functions as a first calculation means in the present invention, and executes a first calculation step in the present invention.

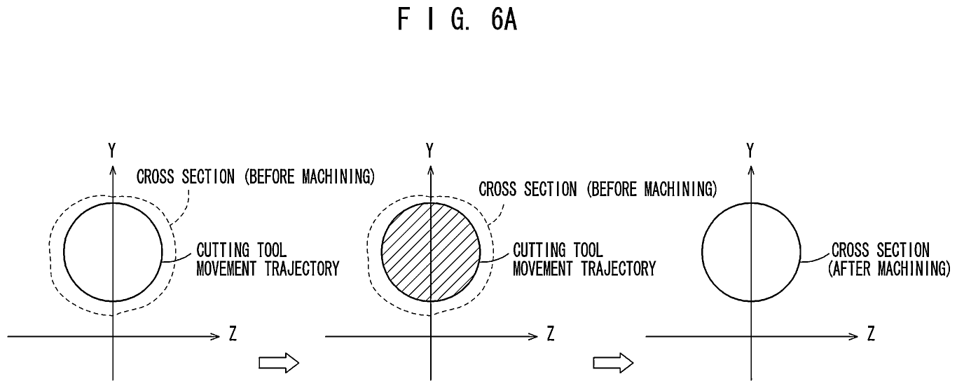

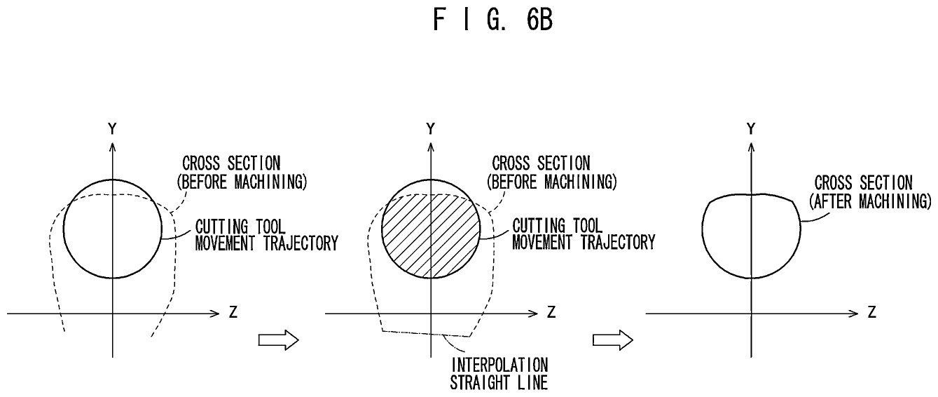

FIG. 6A and FIG. 6B are views each schematically explaining an estimating method of the evaluation object data after machining.

As illustrated in FIG. 6A, when the YZ cross section of the evaluation object data (before machining) represented by a broken line and the region surrounded by a cutting tool movement trajectory represented by a solid line are both closed cross sections, an overlapping region of both the closed cross sections (hatched region) is extracted and this overlapping region is estimated as the cross section of the evaluation object data after machining.

Further, as illustrated in FIG. 6B, when the YZ cross section of the evaluation object data (before machining) represented by a broken line is an open cross section and the region surrounded by a cutting tool movement trajectory represented by a solid line is a closed cross section, after calculating a closed cross section obtained by interpolating the opening of the YZ cross section of the evaluation object data with a shortest straight line (interpolation straight line), the overlapping region of both the closed cross sections (hatched region) is extracted, and this overlapping region is estimated as the cross section of the evaluation object data after machining.

Then, the calculation section 325 calculates the gravitational center and the weight of each of the evaluation object data estimated based on the gravitational centers on two-dimensional planes of a plurality of cross sections orthogonal to the X axis (YZ cross sections of the evaluation object data after machining) at a plurality of positions along the X axis, and predetermined weights set according to the areas of a plurality of the cross sections. Specifically, by integrating the gravitational center and the weight of each of a plurality of the cross sections, the gravitational center (zᵢ, yᵢ) and the weight mᵢ of the evaluation object data at the position of xᵢ in the X-axis direction are calculated.

Incidentally, the weight according to the area of the cross section can be calculated, for example, by multiplying the volume, which is obtained by multiplying the area of the cross section by the pitch of the cross section (1 mm in this embodiment), by a predetermined value set in advance, and can be calculated by multiplying the above-described volume by the density of the material forming the crankshaft S, for example.

As above, the calculation section 325 functions as a second calculation means in the present invention, and executes a second calculation step in the present invention.

Then, the calculation section 325 calculates the imbalance amount of the crankshaft S based on the gravitational center (zᵢ, yᵢ) and the weight mᵢ of the evaluation object data at the position of xᵢ in the X-axis direction. Specifically, based on Equation (1) to Equation (6) described above, imbalance amounts M_{A} (M_{Az}, M_{Ay}) and M_{B} (M_{Bz}, M_{By}) are calculated. In this embodiment, n=8 illustrated in Equation (4) to Equation (6) is established.

As above, the calculation section 325 functions as a third calculation means in the present invention, and executes a third calculation step in the present invention. Further, the imbalance amount of the crankshaft S calculated based on Equation (1) to Equation (6) described above is an example of the information on the balance of the crankshaft in the present invention.

Incidentally, the crankshaft S is generally provided with an oil hole for supplying a lubricating oil in order to lubricate the journals SB and the pins SD. This oil hole is machined so as not to affect the rotational balance, and thus, it does not necessarily need to be considered when calculating the imbalance amount, but it can also be considered by the following procedure.

That is, it is also possible that similarly to the cutting tool movement trajectory, information on a machining region of the oil hole is stored in the storage unit 31 in advance and the area and the weight of the region where the oil hole is located in each of the cross sections of the evaluation object data are integrated as negative values, and thereby, the gravitational center (zᵢ, yᵢ) and the weight mᵢ of the evaluation object data at the position of xᵢ in the X-axis direction are calculated, and based on the values, the imbalance amounts M_{A} and M_{B} of the crankshaft S are calculated.

As described above, the surface shape of the crankshaft S is measured by a plurality of the surface shape measuring parts 1 each arranged around the rotation center axis L of the crankshaft S. A plurality of the surface shape measuring parts 1 are arranged so that the surface shape of the crankshaft S over substantially the entire circumference is measured (for example, the four surface shape measuring parts 1 are arranged at a pitch of 90°) and are moved relative to the crankshaft S by the positioning device parts 2, thereby enabling measurement of the surface shape of the crankshaft S over substantially the entire length. That is, it is possible to measure the surface shape of the crankshaft S over substantially the entire circumference and substantially the entire length.

However, when optically measuring the surface shape of the crankshaft S with the surface shape measuring parts 1 arranged around the rotation center axis L of the crankshaft S, a missing part may occur in measurement results of the surface orthogonal to the rotation center axis L. Specifically, the lights projected from the surface shape measuring parts 1 do not reach the entire side surface of the arm SC of the crankshaft S (the entire surface of the arm SC orthogonal to the rotation center axis L), to cause a missing part in the measurement results in some cases.

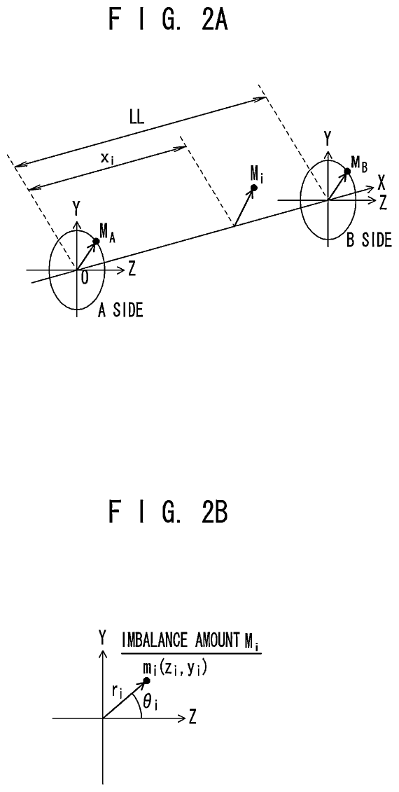

Thus, the arithmetic processing unit 32 of the arithmetic processing device 3 generates three-dimensional point cloud data by combining the measurement results of a plurality of the surface shape measuring parts 1, aligns the three-dimensional point cloud data with the surface shape model read from the storage unit 31, and generates surface data based on the three-dimensional point cloud data that have been aligned. Then, the arithmetic processing unit 32 extracts, from the surface data, the evaluation object data, which are the surface data of the evaluation object portion including at least the arm SC of the crankshaft S, and calculates the gravitational centers and the areas of the cross sections orthogonal to the X axis at a plurality of positions along the X axis of the evaluation object data (the designed rotation center axis of the crankshaft S). The gravitational center and the area of the cross section orthogonal to the X axis can be calculated even if a missing part occurs in the surface data within the cross section (for example, the surface data corresponding to the side surface of the arm SC), as long as the surface data of the portion corresponding to the outer edge of the cross section exist. Accordingly, the arithmetic processing unit 32 can calculate the gravitational center and the weight of the evaluation object data based on the gravitational centers of the cross sections and predetermined weights set according to the areas of the cross sections at a plurality of positions along the X axis of the evaluation object data, which are calculated as described above. Then, the arithmetic processing unit 32 can calculate the imbalance amount of the crankshaft S (corresponding to the imbalance amounts M_{A} and M_{B} illustrated in FIG. 2) based on the gravitational center and the weight of the evaluation object data (in other words, based on the imbalance amount Mᵢ illustrated in FIG. 2).

As above, when calculating the imbalance amount of the crankshaft S, such solidification processing and subtraction processing as described in Patent Literatures 2 and 3 are not required, resulting in that the imbalance amount can be calculated at high speed.

As above, even if there is a missing part in the measurement results of the surface shape of the crankshaft S (for example, the measurement results of the side surface of the arm SC), the imbalance amounts M_{A} and M_{B} of the crankshaft S can be calculated at high speed.

In this embodiment, there has been explained, as an example, the case where the surface shape of the crankshaft S before machining is measured and the imbalance amount of the crankshaft S after machining is calculated. In this case, the imbalance amount of the crankshaft after machining can be calculated (estimated) at the stage before machining, and thus, it is possible to confirm whether or not this imbalance amount is adjustable enough to be adjusted by drilling a hole in the counterweight of the arm. If it is possible to confirm whether or not the imbalance amount is adjustable enough, unnecessary machining can be omitted and at the same time, feedback can be provided to the manufacturing process, to thereby improve the manufacturing process as early as possible.

Incidentally, the present invention is not limited to this, and the surface shape of the crankshaft S before machining can be measured to calculate the imbalance amount of the crankshaft S before machining, and further the surface shape of the crankshaft S after machining can also be measured to calculate the imbalance amount of the crankshaft S after machining.

When measuring the surface shape of the crankshaft S before machining and calculating the imbalance amount of the crankshaft S before machining, or when measuring the surface shape of the crankshaft S after machining and calculating the imbalance amount of the crankshaft S after machining, it is only necessary to use the extracted evaluation object data as they are (without estimating the evaluation object data after machining), calculate the gravitational center and the weight of the evaluation object data, and calculate the imbalance amount of the crankshaft S based on the calculated values.

In this embodiment, the arm SC is set to the evaluation object portion, but the present invention is not limited to this, and any evaluation object portion that includes at least the arm SC may be used. As long as the longer calculation time of the imbalance amount does not interfere with performing the total inspection of the crankshaft S, the entire crankshaft S can be set to the evaluation object portion.

Incidentally, the information based on the imbalance amount of the crankshaft S calculated using the balance inspection apparatus 100 according to this embodiment is preferably displayed on the surface by means of letters or codes. This makes it possible, when machining the crankshaft S, to easily perform operations such as shifting the center axis of machining slightly based on the information based on the imbalance amount displayed on the surface. As the codes, bar codes or two-dimensional codes such as QR codes (registered trademarks) can be used. For displaying letters or codes on the surface of the crankshaft S, methods such as marking with ink and laser engraving can be used.

The following is one example of the results obtained by calculating the gravitational center and the weight of the evaluation object data and the results obtained by calculating the imbalance amount of the crankshaft S (imbalance amount before machining) using the balance inspection apparatus 100 according to this embodiment (a balance inspection apparatus according to an example), a balance inspection apparatus according to a reference example, and a balance inspection apparatus according to a comparative example, respectively, with the crankshaft S that is imbalanced during rotation (before machining) set as an object. In all the cases of the example, the reference example, and the comparative example, the evaluation object portion is the eight arms SC.

As for the balance inspection apparatus according to the example, as the surface shape measuring part, four high-speed shape meters that measure the surface shape by an optical cutting method were used as described above. The surface shape of the crankshaft S over substantially the entire circumference and substantially the entire length was able to be measured at high speed within 10 seconds, and the measurement accuracy was 0.2 mm (1σ). As described above, to calculate the gravitational center and the weight of the evaluation object data, the gravitational centers and the areas of YZ cross sections at a plurality of positions along the X axis of the evaluation object data were used (this is hereinafter referred to as the “cross-sectional method”). The time required to calculate the gravitational center and the weight of the evaluation object data by the cross-sectional method was within 10 sec.

As the surface shape measuring part of the balance inspection apparatus according to the reference example, a non-contact precision shape meter (CRYSTA-APEX manufactured by Mitutoyo Corporation, measurement accuracy within 0.05 mm), which enables highly accurate measurement, was used although time is required to measure surface shapes. The cross-sectional method was used to calculate the gravitational center and the weight of the evaluation object data, as in the example.

As the surface shape measuring part of the balance inspection apparatus according to the comparative example, a non-contact precision shape meter was used as in the reference example. To calculate the gravitational center and the weight of the evaluation object data, as in the technique described in Patent Literature 2, a method of performing solidification processing and subtraction processing (this is hereinafter referred to as the “volumetric method”) was used after converting the three-dimensional point cloud data to surface data. The amount of calculation required to use volumetric data was large, and thus the time required to calculate the gravitational center and the weight of the evaluation object data by the volumetric method was 20 minutes or more.

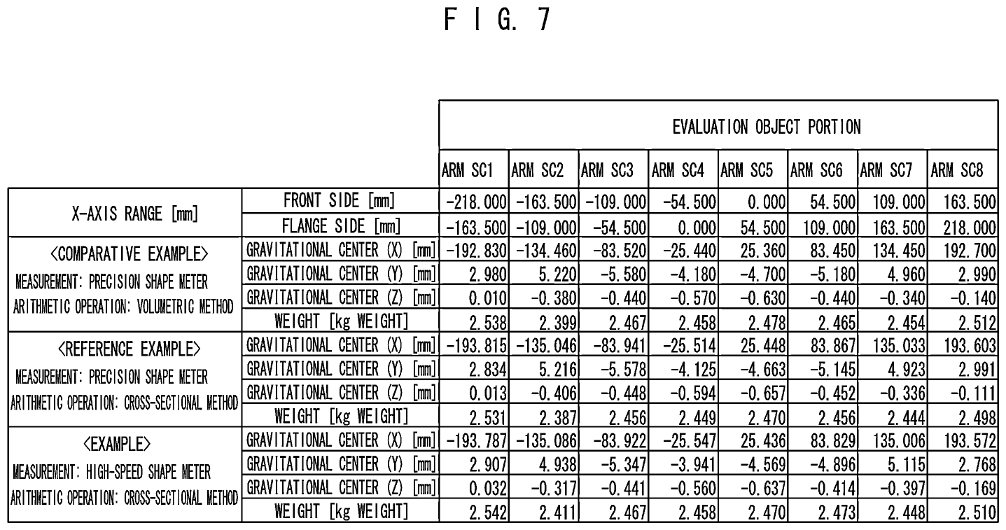

FIG. 7 illustrates examples of the results obtained by calculating the gravitational centers and the weights of the evaluation object data (surface data of the first arm SC1 to the eighth arm SC8, which are evaluation object portions) by the balance inspection apparatuses according to the example, the reference example, and the comparative example. In FIG. 7, the numerical value illustrated in the column of “GRAVITATIONAL CENTER (X)” is the X-axis coordinate of the gravitational center of each evaluation object data, and the numerical value illustrated in the column of “GRAVITATIONAL CENTER (Y)” is the Y-axis coordinate of the gravitational center of each evaluation object data, and the numerical value illustrated in the column of “GRAVITATIONAL CENTER (Z)” is the Z-axis coordinate of the gravitational center of each evaluation object data.

As can be seen by comparing the results of the reference example and the comparative example using the same surface shape measuring part, the maximum difference between the calculated gravitational centers is 0.14 mm and the maximum difference between the calculated weights is 0.014 kg weight, indicating that the accuracy of calculating the gravitational center and the weight by the cross-sectional method is as high as that of the conventional volumetric method.

Further, as can be seen by comparing the results of the comparative example and the example using the same surface shape measuring part, the maximum difference between the calculated gravitational centers is 0.28 mm, and the maximum difference between the calculated weights is 0.012 kg weight. Considering that the measurement accuracy (1σ) of the surface shape measuring part by the high-speed shape meter is 0.2 mm, this is estimated to be a reasonable calculation accuracy.

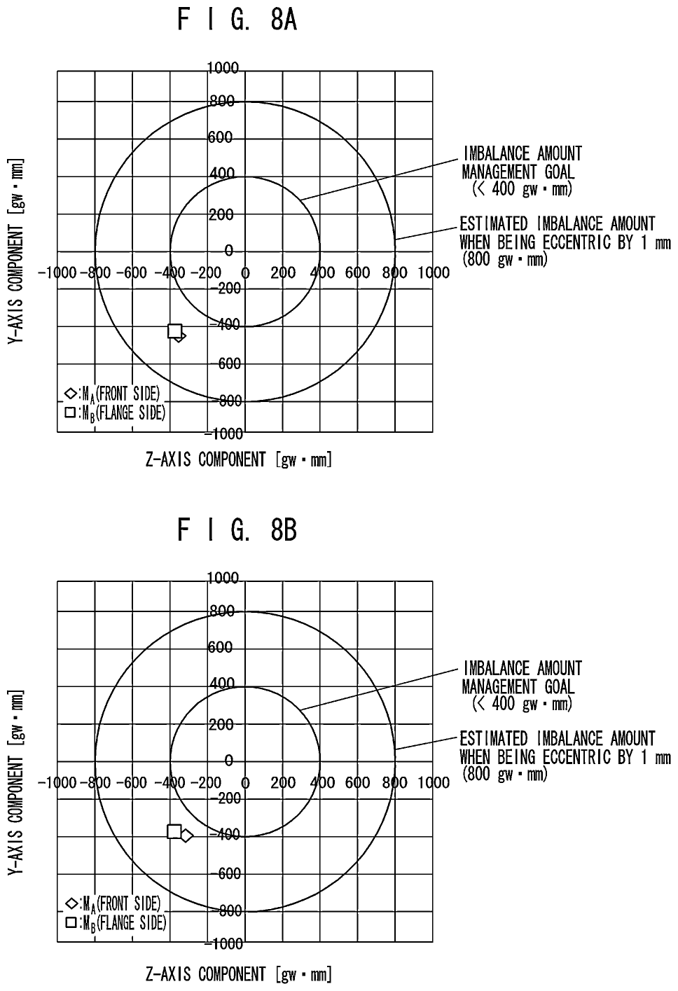

FIG. 8A and FIG. 8B illustrate one example of the results obtained by calculating the imbalance amounts M_{A} and M_{B} of the crankshaft S by the balance inspection apparatuses according to the example and the comparative example. FIG. 8A illustrates a calculation result in the comparative example, and FIG. 8B illustrates a calculation result in the example. In FIG. 8A and FIG. 8B, the horizontal axis indicates the Z-axis component (M_{Az}, M_{Bz}), and the vertical axis indicates the Y-axis component (M_{Ay}, M_{By}).

As can be seen by comparing the result illustrated in FIG. 8A and the result illustrated in FIG. 8B, the difference between the two is within ±50 gw·cm, and it can be said that the balance inspection apparatus according to the example can calculate the imbalance amount as accurately as the conventional balance inspection apparatus in the comparative example.

Incidentally, as illustrated in FIG. 8A and FIG. 8B, in the case of the crankshaft S set as an object, if the center of gravity is eccentric by 1 mm, an imbalance amount of 800 gw·cm occurs, and thus it can be said that an eccentricity of 0.06 mm (=1/(800/50)) can be detected. This is sufficient performance to control the balance quality of a forged product of the crankshaft S.

This embodiment can be implemented by a computer executing a program. Further, a computer-readable recording medium recording the above-described program and a computer program product such as the above-described program can also be applied as the embodiment of the present invention. As the recording medium, for example, a flexible disk, a hard disk, an optical disk, a magneto-optical disk, a CD-ROM, a magnetic tape, a nonvolatile memory card, a ROM, and so on can be used.

Hereinbefore, the present invention has been described with an embodiment, but the above-described embodiment merely illustrates concrete examples of implementing the present invention, and the technical scope of the present invention is not to be construed in a restrictive manner by these embodiments. That is, the present invention may be implemented in various forms without departing from the technical spirit or main feature thereof.

1. A balance inspection apparatus that calculates information on balance of a crankshaft. the apparatus comprising:
a plurality of surface shape measuring parts that are each arranged around a rotation center axis of the crankshaft and optically measure a surface shape of the crankshaft;
a positioning device part that moves the surface shape measuring part relative to the crankshaft in the direction of the rotation center axis of the crankshaft;
a storage unit that stores a surface shape model, the surface shape model in which a designed surface shape of the crankshaft is defined in a coordinate system in which a designed rotation center axis of the crankshaft is an X axis; and
an arithmetic processing unit that calculates information on balance of the crankshaft based on measurement results of a plurality of the surface shape measuring parts, wherein
a plurality of the surface shape measuring parts are arranged to measure a surface shape of the crankshaft over substantially the entire circumference and moved relative to the crankshaft by the positioning device part, to thereby measure a surface shape of the crankshaft over substantially the entire length, and
the arithmetic processing unit
combines measurement results of a plurality of the surface shape measuring parts, to thereby generate three-dimensional point cloud data consisting of data points corresponding to points of a surface of the crankshaft,
aligns the three-dimensional point cloud data with the surface shape model read from the storage unit in a coordinate system of the surface shape model,
based on the three-dimensional point cloud data that have been aligned, generates surface data represented by a collection of planes passing through three data points that constitute the three-dimensional point cloud data,
extracts, from the surface data, evaluation object data, which are surface data of an evaluation object portion including at least an arm of the crankshaft, and calculates gravitational centers and areas of cross sections orthogonal to the X axis at a plurality of positions along the X axis of the evaluation object data,
calculates a gravitational center and a weight of the evaluation object data based on the gravitational centers of the cross sections and predetermined weights set according to the areas of the cross sections, and
calculates information on balance of the crankshaft based on the gravitational center and the weight of the evaluation object data.

2. The balance inspection apparatus according to claim 1, wherein
a plurality of the surface shape measuring parts optically measure a surface shape of the crankshaft before machining,
the storage unit stores information on machining of the crankshaft, and
the arithmetic processing unit
estimates evaluation object data after machining based on the extracted evaluation object data and the information on machining read from the storage unit,
calculates gravitational centers and areas of cross sections orthogonal to the X axis at a plurality of positions along the X axis of the estimated evaluation object data after machining,
calculates a gravitational center and a weight of the estimated evaluation object data after machining based on the gravitational centers of the cross sections and predetermined weights set according to the areas of the cross sections, and
calculates information on balance of the crankshaft after machining based on the gravitational center and the weight of the estimated evaluation object data after machining.

3. A balance-inspected crankshaft with information based on the information on the balance of the crankshaft calculated using the balance inspection apparatus according to claim 1 displayed on a surface thereof by means of letters or codes.

4. A balance inspection method that calculates information on balance of a crankshaft, the method comprising:
using a balance inspection apparatus including:
a plurality of surface shape measuring parts that are each arranged around a rotation center axis of the crankshaft and optically measure a surface shape of the crankshaft;
a positioning device part that moves the surface shape measuring part relative to the crankshaft in the direction of the rotation center axis of the crankshaft;
a storage unit that stores a surface shape model, the surface shape model in which a designed surface shape of the crankshaft is defined in a coordinate system in which a designed rotation center axis of the crankshaft is an X axis; and
an arithmetic processing unit that calculates information on balance of the crankshaft based on measurement results of a plurality of the surface shape measuring parts;
a plurality of the surface shape measuring parts are arranged to measure a surface shape of the crankshaft over substantially the entire circumference and moved relative to the crankshaft by the positioning device part, to thereby measure a surface shape of the crankshaft over substantially the entire length, and
the arithmetic processing unit
combines measurement results of a plurality of the surface shape measuring parts, to thereby generate three-dimensional point cloud data consisting of data points corresponding to points of a surface of the crankshaft,
aligns the three-dimensional point cloud data with the surface shape model read from the storage unit in a coordinate system of the surface shape model,
based on the three-dimensional point cloud data that have been aligned, generates surface data represented by a collection of planes passing through three data points that constitute the three-dimensional point cloud data,
extracts, from the surface data, evaluation object data, which are surface data of an evaluation object portion including at least an arm of the crankshaft, and calculates gravitational centers and areas of cross sections orthogonal to the X axis at a plurality of positions along the X axis of the evaluation object data,
calculates a gravitational center and a weight of the evaluation object data based on the gravitational centers of the cross sections and predetermined weights set according to the areas of the cross sections, and
calculates information on balance of the crankshaft based on the gravitational center and the weight of the evaluation object data.

5. The balance inspection method according to claim 4, wherein,
a plurality of the surface shape measuring parts optically measure a surface shape of the crankshaft before machining,
the storage unit stores information on machining of the crankshaft, and
the arithmetic processing unit
estimates evaluation object data after machining based on the extracted evaluation object data and the information on machining read from the storage unit,
calculates gravitational centers and areas of cross sections orthogonal to the X axis at a plurality of positions along the X axis of the estimated evaluation object data after machining,
calculates a gravitational center and a weight of the estimated evaluation object data after machining based on the gravitational centers of the cross sections and predetermined weights set according to the areas of the cross sections, and
calculates information on balance of the crankshaft after machining based on the gravitational center and the weight of the estimated evaluation object data after machining.

6. A balance-inspected crankshaft with information based on the information on the balance of the crankshaft calculated using the balance inspection method according to claim 4 displayed on a surface thereof by means of letters or codes.

7. An arithmetic processing device that calculates information on balance of a crankshaft, the device comprising:
a computer processor including processing circuitry programmed to perform operations comprising:
store a surface shape model in a storage unit, the surface shape model in which a designed surface shape of the crankshaft is defined in a coordinate system in which a designed rotation center axis of the crankshaft is an X axis;
align three-dimensional point cloud data, the three-dimensional point cloud data generated based on results obtained by optically measuring a surface shape of the crankshaft and consisting of data points corresponding to points of a surface of the crankshaft, with the surface shape model read from the storage unit in a coordinate system of the surface shape model;
generate surface data represented by a collection of planes passing through three data points that constitute the three-dimensional point cloud data, based on the three-dimensional point cloud data that have been aligned;
extract, from the surface data evaluation object data, which are surface data of an evaluation object portion including at least an arm of the crankshaft, and calculate gravitational centers and areas of cross sections orthogonal to the X axis at a plurality of positions along the X axis of the evaluation object data;
calculate a gravitational center and a weight of the evaluation object data based on the gravitational centers of the cross sections and predetermined weights set according to the areas of the cross sections, and
calculate information on balance of the crankshaft based on the gravitational center and the weight of the evaluation object data.

8. The arithmetic processing device according to claim 7, wherein
the three-dimensional point cloud data are generated based on results obtained by optically measuring a surface shape of the crankshaft before machining,
the computer processor including processing circuitry programmed to perform operations comprising:
estimate evaluation object data after machining based on the extracted evaluation object data and information on machining prepared in advance, and calculate gravitational centers and areas of cross sections orthogonal to the X axis at a plurality of positions along the X axis of the evaluation object data after machining,
calculate a gravitational center and a weight of the evaluation object data after machining based on the gravitational centers of the cross sections and predetermined weights set according to the areas of the cross sections, and
calculate information on balance of the crankshaft after machining based on the gravitational center and the weight of the evaluation object data after machining.

9. (canceled)

10. (canceled)
